(19) United States
(12) Patent Application Publication
(10) Pub. No.: US 2026/0043264 A1
(43) Pub. Date: Feb. 12, 2026

(54) Digital Streaming Headstone

(71) Applicant: Willie Walker, White City, OR (US)

(72) Inventor: Willie Walker, White City, OR (US)

(21) Appl. No.: 19/292,075

(22) Filed: Aug. 6, 2025

Related U.S. Application Data
(60) Provisional application No. 63/681,203, filed on Aug. 9, 2024.

(51) Int. Cl. E04H 13/00; G06F 3/041; G06F 3/16; H02J 7/35

(52) U.S. Cl. CPC E04H 13/001; G06F 3/0412; G06F 3/167; H02J 7/35; H02J 2300/22

(57) ABSTRACT

Expanding on the initial design of a traditional tombstone, the disclosure introduces a novel granite headstone or mausoleum equipped with a waterproof Bluetooth digital device that allows families to preserve and cherish precious memories of their departed loved ones and to access these stored records at their leisure. Users can upload pictures, videos, and voice memos directly onto the tombstone to offer a means of keeping the memory and spirit of the deceased alive. To access, view, and upload content, users will have a designated code that ensures privacy and security, for the code is only given to the purchaser, who can then choose to share it with trusted family members, friends, and/or social acquaintances, ensuring that only those who are authorized can access the content stored within.

### SUMMARY OF THE INVENTION

Expanding on the initial design of a traditional tombstone, the disclosure introduces a novel granite headstone or mausoleum equipped with a waterproof Bluetooth digital device that allows families to preserve and cherish precious memories of their departed loved ones and to access these stored records at their leisure. Users can upload pictures, videos, and voice memos directly onto the tombstone to offer a means of keeping the memory and spirit of the deceased alive. To access, view, and upload content, users will have a designated code that ensures privacy and security, for the code is only given to the purchaser, who can then choose to share it with trusted family members, friends, and/or social acquaintances, ensuring that only those who are authorized can access the content stored within.

More specifically, a marker accessory for a gravestone and a mausoleum includes a flat screen side comprising a flat screen and an enabling electronics to drive the flat screen, wherein the flat screen side comprises an outside surface and a flat screen surface. Also, the marker accessory includes a locking hinge disposed on one end of the flat screen side. Furthermore, the marker accessory includes a lid configured to cover the flat screen surface and comprise an outside surface and configured to attach to the locking hinge on a side complementary to the flat screen one end. A digital memory disposed in one of the flat screen side and the lid to store and provide accessibility to the memories of a deceased.

### BRIEF DESCRIPTION OF THE DRAWINGS

FIG. 1 is a front perspective view of the Digital Streaming Headstone in a flipped up configuration in accordance with an embodiment of the present disclosure.

FIG. 2 is a front perspective view of the Digital Streaming Headstone in a flipped down configuration in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout this specification, the terms marker, gravestone, tombstone, mausoleum marker are interchangeable and refer to a marker for a deceased in a grave, mausoleum and an urn or receptacle for ashes or remains of a deceased.

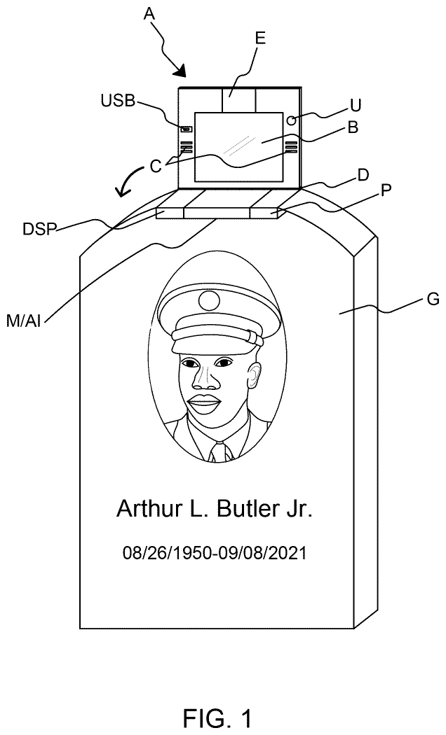

FIG. 1 is a front perspective view of the digital streaming headstone in a flipped up position in accordance with an embodiment of the present disclosure. The view includes the water proof Bluetooth™ digital device A, the digital locked screen B accessible only with a password, the speakers C, the hinge D, the tombstone G. The view also includes the enabling electronics E for the flat screen B, the USB port and waterproof plug, the digital signal processor DSP, the memory and artificial intelligence M/AI, the power/battery P and the microphone U.

The disclosure, also known as “Last Impressions” expands upon the function of traditional headstones by incorporating cutting-edge technology displaying digital streaming content about a deceased person's life in an effort to provide solace and comfort to the loved ones left behind. The grieving process can be incredibly difficult, and many struggle with the fear of forgetting or losing the essence of their departed loved ones, post a formal funeral or remembrance ceremony. In today's digital age, memories are often scattered across various devices and platforms, risking the loss of pictures, recorded history, and other aspects of a deceased individual, over the course of time. Ingenious and practical, Last Impressions offers a modern adaptation to tombstones, providing a dedicated platform for families to store and access video footage, pictures, and/or slides, all showcasing the life of the deceased.

Expanding on the initial design of a traditional tombstone, Last Impressions introduces a novel granite headstone or mausoleum equipped with a waterproof Bluetooth digital device that allows families to preserve and cherish precious memories of their departed loved ones and to access these stored records at their leisure. Users can upload pictures, videos, and voice memos directly onto the tombstone to offer a means of keeping the memory and spirit of the deceased alive. To access, view, and upload content, users will have a designated code that ensures privacy and security, for the code is only given to the purchaser, who can then choose to share it with trusted family members, friends, and/or social acquaintances, ensuring that only those who are authorized can access the content stored within.

By centralizing these memories in one accessible location, this innovative, top-quality product guarantees that cherished moments are preserved and can be revisited anytime. As a result, Last Impressions may prove to be essential in the novelty/miscellaneous industry.

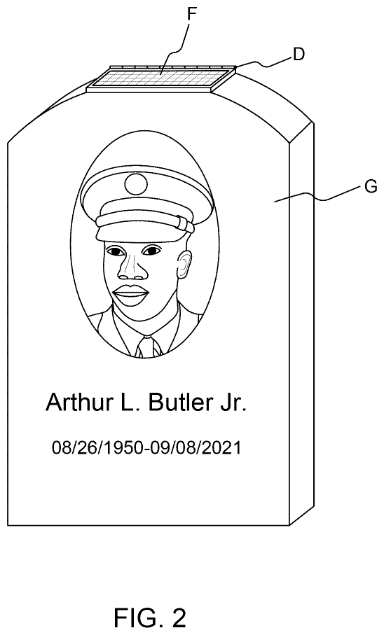

FIG. 2 is a front perspective view of the digital streaming headstone in a flipped down position in accordance with an embodiment of the present disclosure. This view includes the solar panel F not shown in FIG. 1 on a top surface of the water proof bluetooth digital device. The digital screen B is covered by the lid of the device and swings on top via the hinge. The tombstone itself may embed a digital streaming device a screen in other implementations.

Embodiments of the marker accessory are disclosed wherein the lid is attached to the marker and a solar cell on the outside surface of the flat screen side and configured to power the marker accessory. A battery powers the marker accessory disposed in one of the flat screen side and the lid.

Embodiments also include the flat screen outer surface attached to the marker and a solar cell is disposed on the outside surface of the lid and configured to power the marker accessory. Alternatively, an alternating current (AC) power wired to the marker accessory and a mausoleum marker on the outside surface of the flat screen side. Also, an alternating current (AC) power wired to the marker accessory and a granite marker on the outside surface of the flat screen side.

Additional embodiments include a USB port and waterproof port plug on the flat screen surface configured to accept an auxiliary power and an electronic input/output to the marker accessory. At least one speaker is electrically connected to the enabling electronics and the digital memory and disposed on one of the flat screen side and the lid.

A voice activated release of the locking hinge allows the flat screen side to move into a viewing position relative to the marker. The marker accessory permanently attaches to one of a flat, a bevel, a slanted, an upright, and a specialty gravestone. An internal electromagnetic wireless antennae for an input/output to the marker accessory electronics and digital memory.

Further embodiments include the flat screen as a touch screen for user input/output and management of the marker accessory. Accordingly a voice activated security login provides secured access to the marker accessory. The marker accessory further comprising a weather proof seal of the flat screen surface against the lid.

The marker accessory yet includes an artificial intelligence comprising a voice likeness and a conversational ability matching a deceased person associated with the marker accessory.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A marker accessory for a gravestone and a mausoleum and comprising:
a flat screen side comprising a flat screen and an enabling electronics to drive the flat screen, wherein the flat screen side comprises an outside surface and a flat screen surface; a locking hinge disposed on one end of the flat screen side; a lid configured to cover the flat screen surface and comprise an outside surface and configured to attach to the locking hinge on a side complementary to the flat screen one end; and
a digital memory disposed in one of the flat screen side and the lid.

2. The marker accessory of claim 1, wherein the lid is attached to the marker and further comprising a solar cell on the outside surface of the flat screen side and configured to power the marker accessory.

3. The marker accessory of claim 1, further comprising a battery configured to power the marker accessory and to be disposed in one of the flat screen side and the lid.

4. The marker accessory of claim 1, wherein the flat screen outer surface is attached to the marker and a solar cell is disposed on the outside surface of the lid and configured to power the marker accessory.

5. The marker accessory of claim 1, further comprising an alternating current (AC) power wired to the marker accessory and a mausoleum marker on the outside surface of the flat screen side.

6. The marker accessory of claim 1, further comprising an alternating current (AC) power wired to the marker accessory and a granite marker on the outside surface of the flat screen side.

7. The marker accessory of claim 1, further comprising a USB port and waterproof port plug on the flat screen surface configured to accept an auxiliary power and an electronic input/output to the marker accessory.

8. The marker accessory of claim 1, further comprising at least one speaker electrically connected to the enabling electronics and the digital memory and disposed on one of the flat screen side and the lid.

9. The marker accessory of claim 1, further comprising a voice activated release of the locking hinge configured to allow the flat screen side to move into a viewing position relative to the marker.

10. The marker accessory of claim 1, wherein the marker accessory permanently attaches to one of a flat, a bevel, a slanted, an upright, and a specialty gravestone.

11. The marker accessory of claim 1, further comprising an internal electromagnetic wireless antennae for an input/output to the marker accessory electronics and digital memory.

12. The marker accessory of claim 1, wherein the flat screen is a touch screen for user input/output and management of the marker accessory.

13. The marker accessory of claim 1, further comprising a voice activated security login for secured access to the marker accessory.

14. The marker accessory of claim 1, further comprising a weather proof seal of the flat screen surface against the lid.

15. The marker accessory of claim 1, further comprising an artificial intelligence comprising a voice likeness and a conversational ability matching a deceased person associated with the marker accessory.
